(19) United States
(12) Patent Application Publication
(10) Pub. No.: US 2026/0269778 A1
(43) Pub. Date: Sep. 10, 2026

(54) TANDEM VEHICULAR MAINTENANCE OF PHOTOVOLTAIC MODULES

(71) Applicant: Nextpower LLC, Fremont, CA (US)

(72) Inventors: Alexander W. AU, Oakland, CA (US); Nathan James Malone, San Mateo, CA (US); Harry Van, Oakland, CA (US); Bethany Ramadan, Fremont, CA (US)

(21) Appl. No.: 19/549,958

(22) Filed: Feb. 25, 2026

Related U.S. Application Data
(60) Provisional application No. 63/768,235, filed on Mar. 7, 2025.

(51) Int. Cl. H02S 40/10; B08B 1/12; B08B 1/34; B08B 1/40; B08B 3/10; B08B 17/02; G05D 1/695

(52) U.S. Cl. CPC H02S 40/10; B08B 1/12; B08B 1/34; B08B 1/40; B08B 3/102; B08B 17/02; G05D 1/696

(57) ABSTRACT

A tandem vehicular photovoltaic maintenance system includes a first vehicle, a second vehicle, a maintenance assembly, and a controller. The first vehicle includes a first vehicle body and one or more wheels coupled to the first vehicle body. The second vehicle includes a second vehicle body and one or more wheels coupled to the second vehicle body. The maintenance assembly includes a brush, and the maintenance assembly is supported at the first vehicle body and at the second vehicle body. The controller is coupled to the maintenance assembly, and the controller is configured to adjust a positioning of the brush relative to each of the first vehicle and the second vehicle and to cause the brush to be rotatably driven relative to each of the first vehicle and the second vehicle.

### CROSS-REFERENCE TO RELATED APPLICATIONS

This application claims the benefit of U.S. Provisional Patent Application No. 63/768,235, filed Mar. 7, 2025, the entire contents of which is hereby incorporated by reference.

### TECHNICAL FIELD

This disclosure relates generally to maintenance (e.g., cleaning, coating, etc.) of solar power components, such as photovoltaic modules, sometimes referred to as solar modules. Embodiments disclosed herein describe devices, systems, and methods for tandem vehicular maintenance of photovoltaic modules, including, for instance, an autonomous system for tandem vehicular maintenance of photovoltaic modules of a solar tracker, though other embodiments can be applied to perform one or more maintenance operations at other solar power component systems.

### BACKGROUND

Photovoltaic (PV) systems are an essential part of renewable energy infrastructure, converting sunlight into electricity to meet growing energy demands sustainably. PV systems, commonly installed as ground-mounted solar farms or rooftop arrays, rely on the unobstructed exposure of solar panels to sunlight for optimal performance. However, environmental factors such as dust, dirt, bird droppings, and other pollutants accumulate on the surface of solar panels over time, significantly reducing their efficiency and energy output.

### SUMMARY

Traditional methods of cleaning PV panels can be labor-intensive, time-consuming, and, in water-scarce regions, unsustainable. To address these and other challenges, the present disclosure describes embodiments relating to tandem vehicular maintenance of photovoltaic modules.

Such embodiments can include at least two separate vehicular bodies that are configured to act together to perform a maintenance operation at one or more PV modules. The maintenance operation can include the vehicular bodies acting together to clean, coat, and/or perform other maintenance-related task at one or more PV modules. For instance, the maintenance operation can be performed in tandem by the at least two separate vehicular bodies along a row of solar tracker system, with one vehicular body movable along one side of the row and the other vehicular body movable along another (e.g., opposite) side of the row such that the maintenance operation can be performed along a given row in tandem by the at least two separate vehicular bodies. Embodiments disclosed herein can be particularly advantageous for utility-scale solar farms, where, by automating the cleaning process, these systems can reduce operational costs, increase energy yields, and extend the lifespan of solar panels, while minimizing environmental impact.

One embodiment includes a tandem vehicular photovoltaic maintenance system. This tandem vehicular photovoltaic maintenance system embodiment includes a first vehicle, a second vehicle, a maintenance assembly, and a controller. The first vehicle includes a first vehicle body and one or more wheels coupled to the first vehicle body. The second vehicle includes a second vehicle body and one or more wheels coupled to the second vehicle body. The maintenance assembly includes a brush, and the maintenance assembly is supported at the first vehicle body and at the second vehicle body. The controller is coupled to the maintenance assembly, and the controller is configured to adjust a positioning of the brush relative to each of the first vehicle and the second vehicle and to cause the brush to be rotatably driven relative to each of the first vehicle and the second vehicle.

In a further embodiment of this system, the controller is further configured to cause the first vehicle and the second vehicle to move in tandem while the brush is rotatably driven.

In a further embodiment of this system, the controller is further configured to adjust the positioning of the brush relative to each of the first vehicle and the second vehicle by at least adjusting an angular orientation of the brush.

In a further embodiment of this system, the controller is configured to adjust the positioning of the brush relative to each of the first vehicle and the second vehicle by at least adjusting a spacing between the first vehicle and the second vehicle.

In a further embodiment of this system, the first vehicle further includes a first vehicle support shaft coupled to the maintenance assembly, and the second vehicle further comprises a second vehicle support shaft coupled to the maintenance assembly. The controller is configured to move at least one of the first vehicle shaft and the second vehicle shaft to adjust the positioning of the brush relative to each of the first vehicle and the second vehicle. For example, the controller can be configured to raise and lower at least one of the first vehicle shaft and the second vehicle shaft to adjust the positioning of the brush relative to each of the first vehicle and the second vehicle. As another additional or alternative example, the controller can be configured to translate the brush relative to at least one of the first vehicle shaft and the second vehicle shaft to adjust a spacing defined between the first vehicle and the second vehicle.

In a further embodiment of this system, the maintenance assembly is supported at the first vehicle body and at the second vehicle body such that the maintenance assembly extends between the first and second vehicle bodies and over a photovoltaic module at a row of a solar tracker.

In a further embodiment of this system, the maintenance assembly further includes a maintenance fluid applicator, and the controller is configured to cause the maintenance fluid applicator to output a maintenance fluid. For example, the maintenance fluid applicator can be disposed along a first axis that extends between the first vehicle body and the second vehicle body, and the brush can be disposed along a second axis that extends between the first vehicle body and the second vehicle body, with the second axis spaced apart from the first axis. In one such example, the controller can be further configured to cause the maintenance fluid applicator to output a coating material at a first location at a photovoltaic module, and, after the coating material has been output at the first location, the controller can be configured to cause the first vehicle and the second vehicle to move in tandem while causing the brush to be rotatably driven along the first location to finish the coating. In some such examples, the controller is configured to output the coating material at a coating deposition rate, and the controller is configured to cause the first vehicle and the second vehicle to move in tandem at a speed corresponding to the coating deposition rate. In some such examples, the coating material includes a hydrophobic coating that is configured to reduce particulate accumulation at the photovoltaic module.

In a further embodiment of this system, the controller is further configured to cause the maintenance fluid applicator to output a fluid cleaning solution at a first location at a photovoltaic module. And, prior to outputting the fluid cleaning solution at the first location, the controller can be configured to cause the first vehicle and the second vehicle to move in tandem while causing the brush to be rotatably driven along the first location to clean the first location with the brush prior to outputting the fluid cleaning solution at the first location.

In a further embodiment of this system, the maintenance fluid applicator can include an array of nozzles spaced apart along a fluid applicator shaft, and the fluid applicator shaft can be disposed at least partially within the brush.

In a further embodiment of this system, the system additionally includes: a fluid cleaning solution reservoir coupled to the maintenance fluid applicator, a pump coupled to the controller and to the fluid cleaning solution reservoir, and an atomizer coupled between the fluid cleaning solution reservoir and the maintenance fluid applicator to cause atomized fluid cleaning solution output from the maintenance fluid applicator.

Another embodiment includes a method of performing a maintenance operation at one or more photovoltaic modules along a row of a solar tracker system. This method embodiment includes the steps of: moving a first vehicle body and a second vehicle body in tandem relative to the row of the solar tracker system to cause a brush carried by the first vehicle body and the second vehicle body to move along a first photovoltaic module of the row; and outputting a maintenance fluid at the first photovoltaic module as the first vehicle body and the second vehicle body are moved in tandem relative to the row of the solar tracker system.

In a further embodiment of this method, the first vehicle and the second vehicle are moved in tandem at a speed corresponding to a rate at which the maintenance fluid is output.

In a further embodiment of this method, outputting the maintenance fluid includes outputting a hydrophobic coating material. The first vehicle body and the second vehicle body are moved in tandem relative to the row of the solar tracker system in a first direction to cause the hydrophobic coating material to be deposited at the first photovoltaic module. After depositing the hydrophobic coating material at the first photovoltaic module, the brush is moved along the first photovoltaic module in the first direction to finish the coating at the first photovoltaic module.

In a further embodiment of this method, outputting the maintenance fluid includes outputting an atomized fluid cleaning solution. The first vehicle body and the second vehicle body are moved in tandem relative to the row of the solar tracker system in a second, opposite direction to cause the atomized fluid cleaning solution to be output at the first photovoltaic module. Prior to outputting the atomized fluid cleaning solution at the first photovoltaic module, the brush is moved along the first photovoltaic module in the second direction to remove particulate accumulated on the first photovoltaic module.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings.

FIG. 1 is a perspective view of an embodiment of a solar tracker system.

FIG. 2 is a schematic, top view of a solar tracking system arranged in rows of continuous trackers spaced apart from one another, with a tandem vehicular PV maintenance system performing a maintenance operation along a row of the solar tracking system.

FIGS. 3A-3C illustrate elevational views of an embodiment of a tandem vehicular PV maintenance system performing a maintenance operation at PV modules along a row of a solar tracker system, such as at FIG. 2.

FIG. 4A illustrates an elevational view of a first vehicle of the tandem vehicular PV maintenance system of FIGS. 3A-3C. FIG. 4B illustrates a cross-section of the first vehicle of FIG. 4A.

FIG. 5A illustrates an elevational view of a second vehicle of the tandem vehicular PV maintenance system of FIGS. 3A-3C. FIG. 5B illustrates a functional block diagram for outputting a fluid maintenance solution (e.g., outputting a cleaning solution, such as an atomized cleaning liquid solution; outputting a coating; etc.).

FIG. 6 is a top plan view of an embodiment of a tandem vehicular PV maintenance system performing a maintenance operation along a row of a solar tracking system, where the direction that the tandem vehicular PV maintenance system moves relative to the row can vary depending on the type of maintenance operation that the tandem vehicular PV maintenance system is performing at the row.

### DETAILED DESCRIPTION

The following detailed description is exemplary in nature and is not intended to limit the scope, applicability, or configuration of the disclosure in any way. Rather, the following description provides some practical illustrations for implementing examples of the present disclosure. Those skilled in the art will recognize that many of the noted examples have a variety of suitable alternatives.

Embodiments disclosed herein include various devices, systems, and methods relating to tandem vehicular maintenance of photovoltaic modules. Such embodiments can include at least two separate vehicular bodies that are configured to act together to perform a maintenance operation at one or more PV modules. The maintenance operation can include the vehicular bodies acting together to clean, coat, and/or perform other maintenance-related tasks at one or more PV modules.

The present disclosure describes an exemplary application of tandem vehicular maintenance of photovoltaic modules as applied to maintenance operation(s) performed in tandem by the at least two separate vehicular bodies along a row of solar tracker system. As applied to a solar tracker system in such an exemplary application, one vehicular body can be movable along one side of the row and the other vehicular body movable along another (e.g., opposite) side of the row such that the maintenance operation can be performed along a given solar tracker row in tandem by the at least two separate vehicular bodies.

Such embodiments disclosed herein can, in various examples, be autonomous or semi-autonomous robotic systems (e.g., at least two, tandem operated robotic vehicular bodies) designed to maintain (e.g., clean, coat, polish, buff, etc.) the surface of solar panels without damaging them. Such embodiments can include the use advanced mechanisms, such as soft or bristled brushes, air blowers, dry cleaning techniques, fluid cleaning techniques to remove accumulated particulate overlaying PV cells at a PV module. Such embodiments can additionally or alternatively deposit and finish (e.g., buff, polish, etc.) a coating material (e.g., hydrophobic coating material) at the PV module and over the PV cells to reduce future particulate accumulation over the PV cells as a result of the finished coating thereat. Accordingly, embodiments disclosed herein can help to remove and/or reduce accumulation of debris efficiently and sustainably from the surface of a PV module overlaying one or more PV cells. Such embodiments can be equipped with smart sensors, machine learning algorithms, and/or remote monitoring capabilities, and thereby can provide a reliable, efficient, and cost-effective solution for maintaining PV system performance.

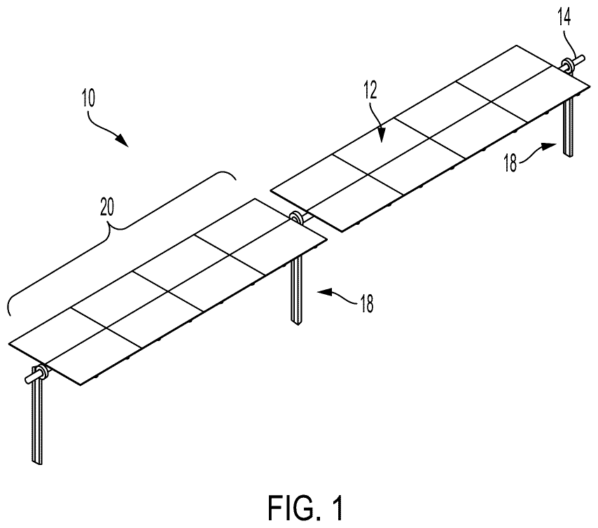

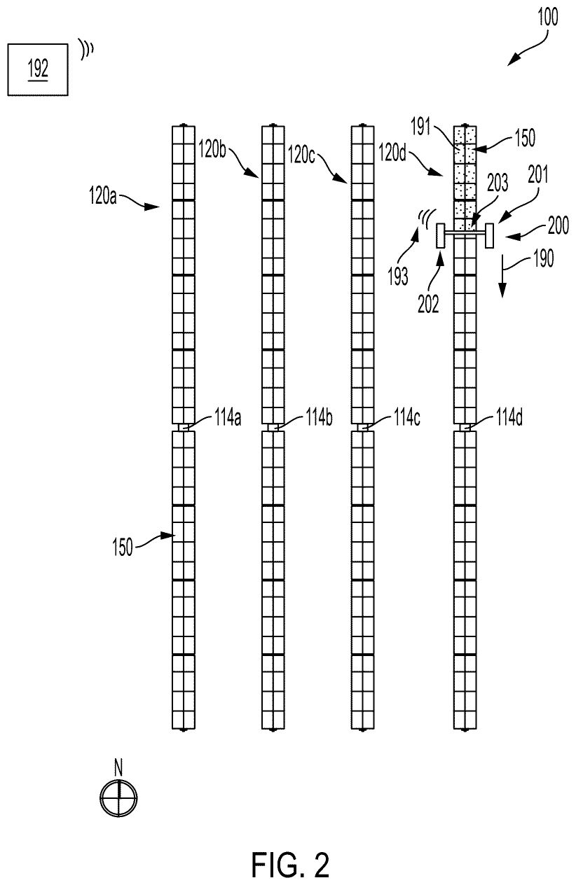

FIG. 1 is an elevation view of an arrangement of a solar tracker 10 provided in accordance with the present disclosure. In some applications, a plurality of solar trackers 10 may be arranged in a north-south longitudinal orientation to form rows of a solar array, such as illustrated at FIG. 2. The solar tracker 10 may be formed of a plurality of bays 20 defined by the distance between ground pile support structures 18 (generally referenced herein as piles 18). The ground piles 18 may be disposed in spaced relation to one another and partially embedded in the earth. In some examples, the ground piles 18 may be multi-component tubular support members, or A-frame supports, and/or may be configured to couple to A-frame supports. The piles 18 may have one or more embedment in the ground, such as one for each leg of an A-frame support where the embedments are spaced apart in the east-west direction. FIG. 1 illustrates two bays 20 of the solar tracker 10. However, it will be appreciated that the solar tracker 10 may include four bays, six bays, ten bays, twenty bays, or any other suitable number of bays as desired. At each pile 18 is either a bearing or generally near the center of the solar tracker 10 a drive mechanism. Each of the bearings and the drive mechanism are supported by one of the piles 18. Activation of the drive mechanism rotates a torque tube 14 about an axis of rotation and thus rotates one or more PV modules (or “solar modules”) 12 mounted to the torque tube 14 such that the PV modules 12 can be oriented to a desired position. That desired position may be to a position to maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the PV modules 12.

The PV modules 12 are supported at the torque tube 14. This is typically achieved by a bracket that is attached to the torque tube 14 substantially perpendicular to the longitudinal axis of the torque tube 14. The torque tube 14 may be rotatable about its longitudinal axis to adjust an angular orientation of the PV modules 12 relative to the sun, while supporting the PV modules 12 on the bracket.

Each PV module 12 of the solar tracker 10 can include one or more PV cells that is configured to convert sunlight into electrical energy. Each PV module can have a plurality of PV cells disposed along on a laminate substrate, and the laminate substrate can be at least partially bounded by a frame. Thus, as sunlight irradiates onto the PV cells, the PV module can generate electrical energy. However, when particulate has accumulated onto the PV module, it can obstruct this electrical generation function of the PV module. Accordingly, maintaining the PV cells substantially unobstructed from accumulated dust, dirt, or other particulate during operation in the field can be useful in reducing or preventing future degradation of the electrical generation function of the PV modules 12 and, thus, tracker 10.

FIG. 2 is a schematic, top view of a solar tracking system 100 arranged in rows of continuous trackers spaced apart from one another. FIG. 2 shows a tandem vehicular PV maintenance system 200 performing a maintenance operation along a row of the solar tracking system 100. The tandem vehicular PV maintenance system 200 can include a first vehicle 201, a second vehicle 202, and a maintenance assembly 203 supported at the first and second vehicles 201, 202. The first and second vehicles 201, 202 can be configured to act together to perform a maintenance operation at one or more PV modules 150. The maintenance operation can include the vehicular bodies 201, 202 acting together to clean, coat, and/or perform other maintenance-related tasks at one or more PV modules 150.

As applied to the solar tracker system 100 shown at FIG. 2, the tandem vehicular PV maintenance system 200 can be configured to move the first and second vehicles 201, 202 in coordination, along with the maintenance assembly 203, relative to a row 120d of PV modules 150 such that the system 200 can execute one or more maintenance operations at the PV modules 150 along the row 120d. For instance, as the first and second vehicles 201, 202 are moved in a coordinated manner relative to the row 120d, the system 200 can be configured to move the maintenance assembly 203 along the surface of the PV modules 150 such that the maintenance assembly 203 performs at least one maintenance operation at the PV module(s) 150 using at least the maintenance assembly 203.

FIG. 2 shows a top view of a solar tracker system 100 composed of a plurality of solar tracker rows, such as for example, a first solar tracker row 120a, a second solar tracker row 120b, a third solar tracker row 120c, and a fourth solar tracker row 120d (generally referred to herein as solar tracker rows 120). The solar tracker rows 120 may be arranged in parallel in a north-south direction, as shown in FIG. 2. It will be appreciated that directional language, e.g., north, south, east, west, referenced herein, is referring generally to such directions and not necessarily to the precise direction. For example, north-south, east-west directions may mean true north-south, true east-west, or approximately north, approximately south, approximately east, or approximately west, for example, within a ±44° range of true north-south, east-west. In some cases, the solar tracker rows 120 may include interior solar tracker rows, such as for example, solar tracker rows 120b, 120c, and exterior solar tracker rows, such as for example, solar tracker rows 120a, 120d. It will be appreciated that interior solar tracker rows are solar tracker rows 120 positioned between two other solar tracker rows 120, and exterior solar tracker rows are solar tracker rows 120 with one other solar tracker row 120 on one side of the exterior solar tracker row and no solar tracker row 120 positioned on the other side, opposite the one side of the exterior solar tracker row. The solar tracker rows 120 may be composed of a plurality of solar module assemblies (“PV modules”) 150 arranged in a north-south longitudinal orientation to form the solar tracker rows 120. The solar module assemblies 150 may include a plurality of solar modules, such as the solar modules 12, as in FIG. 1. Each one of the plurality of solar module assemblies 150 may be supported on a torque tube 114a, 114b, 114c, 114d (generally referred to herein as torque tube 114), which in turn is supported by a plurality of support piers (not explicitly shown in FIG. 2). The torque tube 114 may be an example of the torque tube 14, as in FIG. 1. As shown, the solar tracker rows 120 may be separated by a space, and the first vehicle 201 can be configured to traverse along one space between rows while the second vehicle 202 can be configured to traverse, in a coordinated manner with the first vehicle 201, along another adjacent space. For example, the first vehicle 201 can be configured to traverse along one space between rows while the second vehicle 202 can be configured to traverse, in a coordinated manner with the first vehicle 201, along another space adjacent to the row (e.g., the second vehicle 202 is positioned at a first space at one side of the row 120d while the first vehicle is 201 is positioned at a second space at another, opposite side of the row 120d.

As noted, the tandem vehicular PV maintenance system 200 described herein can be configured to perform one or more maintenance operations at PV modules 150 using at least the maintenance assembly 203. For example, the maintenance assembly 203 can be configured to perform one or more maintenance operations at PV modules 150 including a cleaning operation and/or a coating operation. As one such example of one or more maintenance operations, as shown at FIG. 2, the maintenance assembly 203 can be configured to brush the PV module (e.g., a top surface of the PV module facing the sun) and to output a maintenance solution 191, such as at least one of a fluid cleaning solution and a coating material, at the PV module 150 (e.g., at the same top surface of the PV module facing the sun at which the brush is applied). As shown here, the system 200 can move relative to PV modules 150, for instance relative to a given row 120d, such as in a direction 190. The direction 190 can be a north or south direction such that the system 200 moves relative to the given row 120d in the north or south direction. As shown here, the first vehicle 201 can be positioned at a space at one side of the row 120d, while the second vehicle 202 can be positioned at a space at another, opposite side of the row 120d such that the system 200 is disposed at opposite sides of the row 120d with the maintenance assembly extending generally transverse to the row 120d. For certain embodiments, the system 200 can be configured to move bi-directionally along the given row 120d such that the first and second vehicles 201, 202 can be configured to move in a coordinated manner in both a north and a south direction along the given row 120d. Thus, as the first and second vehicles 201, 202 are moved in a coordinated manner relative to a given PV module 150, the system 200 can output a maintenance solution (e.g., a coating material, a fluid cleaning solution, etc.) from the maintenance assembly 203 at the given PV module 150. Some embodiments can include a brush at the maintenance assembly 203 to brush the given PV module before, after, or during application of the maintenance solution at the PV module 150.

For instance, at shown at FIG. 2, when the system 200 is moved along one or more PV modules 150 in the direction 190, the system 200 can use the maintenance assembly 203 to apply the maintenance solution 191 at the PV modules 150 along the row 120d in the direction 190. The maintenance solution 191 can be, for example, a fluid cleaning solution and/or a coating material. When the maintenance solution 191 is deposited at the PV module 50 via the system 200, the maintenance solution 191 can be configured to at least one of: (i) reduce particulate accumulation at the PV module 150, and (ii) increase sunlight transmission to at least one PV cell at the PV module 150. For instance, for examples where the maintenance assembly 203 outputs a coating material as the maintenance solution 191, the coating material can be finished at the surface of the PV module 150 to reduce future particulate accumulation at the PV module 150. For instance, the coating material can be include a hydrophobic coating material that is configured to repel particulate, such as to repel dirt/dust, from the PV module 150 where the coating material is deposited while allowing for sunlight to pass through the finished coating material to the PV cells over which the coating material has been applied. As another example, where the maintenance assembly 203 outputs a fluid cleaning solution (e.g., liquid cleaning solution and/or pressurized air) as the maintenance solution 191, the fluid cleaning solution can act to remove particulate from the surface of the PV module to thereby increase sunlight transmission to at least one PV cell, which was previously obstructed by the particulate, at the PV module 150.

As shown in FIG. 2, the system 200 can be configured for communication with a remote server 192. In the illustrated example, the system 200 is in wireless communication 193 with the remote server 192. For example, the system 200 can include one or more remotely monitored components (e.g.,. sensors) in data communication with the remote server 192. Accordingly, as the system 200 is operated at one or more PV modules 150, data from the system 200 can be communicated to the remote server 192. This can, for example, facilitate remote monitoring (e.g., real-time) and/or control of the system 200 via the remote server 192. In addition, in some cases, the system 200 can be in bi-directional communication with the remote server 192 such that the remote server 192 can transmit instructions or other data to the system 200, for instance, to actuate a control function at system 200. In some embodiments, the system 200 can integrate with Supervisory Control and Data Acquisition (SCADA) system(s) to enable remote monitoring and control of the system 200. For example, the system 200 can be remotely monitored and controlled as to application of the cleaning solution (e.g., application of the coating material and/or fluid cleaning solution application metrics (volume applied, fluid flow rate of application, temperature of cleaning solution etc.).

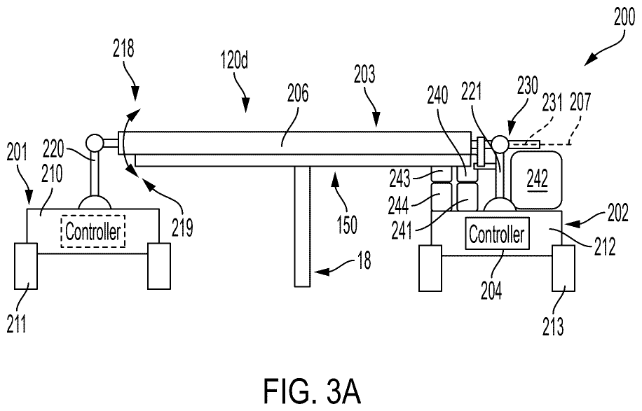

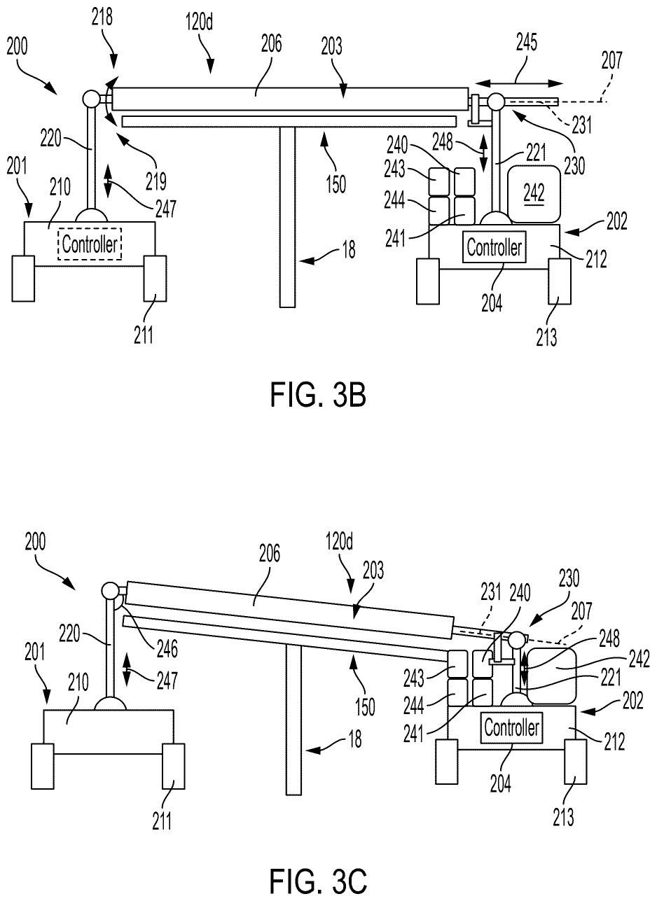

FIGS. 3A-3C illustrate elevational views of an embodiment of the tandem vehicular PV maintenance system 200 performing a maintenance operation at PV modules 150 along a row of a solar tracker system, such as along the row 120d of the solar tracker system 100 at FIG. 2.

The tandem vehicular PV maintenance system 200 can include the first vehicle 201, the second vehicle 202, the maintenance assembly 203, and controller 204. The first vehicle 201 includes a first vehicle body 210 and one or more wheels 211 coupled to the first vehicle body 210. The second vehicle 202 includes a second vehicle body 212 and one or more wheels 213 coupled to the second vehicle body 212. The maintenance assembly 203 is supported at the first vehicle body 210 and at the second vehicle body 212. As such, as the first vehicle body 210 and the second vehicle body 212 are moved relative to the PV module 150, the maintenance assembly 203, supported at the first and second vehicle bodies 210, 212 can move relative to the PV module 150.

The controller 204 can be configured to control the system 200 to perform one or more maintenance operations at one or more PV modules 150. For example, the controller 204 can be configured to move the system 200, such as in an autonomous manner, relative to PV modules 150. This can include the controller 204 being configured to provide coordinated control of the movement of the first vehicle body 210 and the second vehicle body 212 such that the first and second vehicle bodies 210, 212 work in tandem, as specified by the controller 204, to perform one or more maintenance operations using the maintenance assembly 203 as the system 200 is moved (e.g., autonomously moved along the ground surface) relative to PV modules 150. The controller 204 can be coupled to one or more motive sources at the system 200 (e.g., coupled to a motor at the first vehicle body 210 and/or coupled to a motor at the second vehicle body 212) to thereby cause the one or more motive sources at the system 200 to cause the one or more wheels 211 at the first vehicle body 210 and the one or more wheels 213 at the second vehicle body 212 to rotate relative to the vehicle bodies 210, 212 to thereby cause the system 200 to move relative to the PV modules 150. The system 200 can store non-transitory operating code that is executed by a programable processor at the controller 204 to cause the controller 204 to control the system 200 to perform one or more maintenance operations at one or more PV modules 150, such as to provide coordinated control of the movement of the first vehicle body 210 and the second vehicle body 212 such that the first and second vehicle bodies 210, 212 work in tandem, as specified by the controller 204, to perform one or more maintenance operations using the maintenance assembly 203. The illustrated embodiment shows the controller 204 caried at the second vehicle 202, though in other embodiments the controller 204 can instead be carried at the first vehicle 201 or the first and second vehicles 201, 202 can each have a dedicated controller that collectively form controller 204.

To execute a maintenance operation, the controller 204 can be coupled to the maintenance assembly 203, and the maintenance assembly 203 can include at least one maintenance tool 206 (e.g., at least one brush). The controller 204 can be configured to adjust a positioning of the at least one maintenance tool 206, at the maintenance assembly 203, relative to each of the first vehicle 201 (e.g., relative to the first vehicle body 210) and the second vehicle 202 (e.g., relative to the second vehicle body 212). For embodiments where the maintenance tool 206 includes a brush, such as shown here at FIGS. 3A-3C, the controller 204 can be configured to cause both adjustment of a positioning of the brush, at the maintenance assembly 203, relative to each of the first vehicle 201 (e.g., relative to the first vehicle body 210) and the second vehicle 202 (e.g., relative to the second vehicle body 212) and to cause the brush to be rotatably driven relative to each of the first vehicle 201 (e.g., relative to the first vehicle body 210) and the second vehicle 202 (e.g., relative to the second vehicle body 212), for instance, after the brush has been adjusted positionally.

The controller 204 can be to cause the first vehicle 201 and the second vehicle 202 to move in coordinated tandem, such as in the direction 190 (shown at FIG. 2), while the maintenance assembly 203 is actuated to perform at least one maintenance operation at a PV module 150. The illustrated embodiment shows that the maintenance assembly 203 include a maintenance tool as brush 206, though other embodiments can have additional or alternative maintenance tools at the maintenance assembly 203. Controller 204 can be configured to cause brush 206 to be rotatably driven, such as rotatably driven in directions 218, 219. In some cases, controller 204 can be configured to cause brush 206 to be rotatably driven while controller 204 controls the first and second vehicles 201, 202 to move in coordination relative to the PV module 150. This can cause the brush 206 to perform a maintenance operation (e.g., sweeping, buffing, polishing, etc.) at the PV module 150.

Some maintenance operations executable by the system 200 can include use of maintenance solution. As such, the system 200 can further include a maintenance fluid applicator 230 that is configured to output one or more maintenance solutions, such as a coating material and/or a fluid cleaning solution. The embodiment shown here includes the maintenance fluid applicator 230 at the maintenance assembly 203. The controller 204 can be configured to cause the maintenance fluid applicator 230 to output the maintenance fluid, for instance, in coordination with the movement of the first and second vehicle bodies 210, 212. In some examples, the maintenance fluid applicator 230 can be disposed along a first axis 231 that extends between the first vehicle body 210 and the second vehicle body 212.

To output the maintenance solution from the maintenance fluid applicator 230, the controller 204 can be configured to actuate one or more valves at the system 200 to cause maintenance solution to flow from a maintenance solution reservoir 241 (e.g., a fluid cleaning solution reservoir and/or a coating material reservoir) to the maintenance fluid applicator 230, and the controller can be configured to actuate the maintenance fluid applicator 230 to output the maintenance solution at a programmed flow rate and onto the PV module 150. The maintenance solution reservoir 241 can thus be selectively fluidly coupled to the maintenance fluid applicator 230 to start/stop output of maintenance solution, adjust output flow rate of the maintenance solution, and/or switch between different cleaning solution sources/reservoirs (e.g., to switch between outputting a fluid cleaning solution and a coating material). For some embodiments, the system 200 can further include a pump 240 coupled to the controller 204 and to the reservoir 241, as well an atomizer 242 (e.g., a venturi mixer device) coupled between the reservoir 241 and the maintenance fluid applicator 230 to cause atomized maintenance solution (e.g., atomized coating material, atomized fluid cleaning solution, etc.) to be output from the maintenance fluid applicator 203. For some maintenance operations executed by the maintenance assembly 203, compressed air may be a type of maintenance solution output by the maintenance fluid applicator 230 or other component. For such applications, the system 200 can additionally include an air compressor 243 and an air source 244 (e.g., air cylinder; ambient air intake with associated filter), for instance, controllable by the controller 204. The air compressor 243 can be configured to pressurize air received from air source 244 such that pressurized air can be communicated to the maintenance fluid applicator 230 for output at the PV module 150.

As shown at FIG. 3A, the maintenance assembly 203 is supported at the first vehicle body 201 and at the second vehicle body 202. As also shown at FIG. 3A, the maintenance fluid applicator 230 is supported at least at one of the first vehicle body 201 and the second vehicle body 202, The maintenance assembly 203 can be supported at the first and second vehicle bodies 201, 202 such that the maintenance assembly 203 extends between the first and second vehicle bodies 201, 202 and over PV module 150 at a row of a solar tracker. In some examples, the controller 204 can be configured to adjust the support mechanism for the maintenance assembly 203 at the first vehicle body 201 in coordination with the support mechanism for the maintenance assembly 203 at the second vehicle body 202 to orient a longitudinal axis 207 of the brush 206 generally perpendicular to the PV module 150, as shown at the examples of each of FIGS. 3A-3C.

The controller 204 can be configured to cause the system 200 to output one or more maintenance solutions. For instance, the controller 204 can be configured to control tandem movement of the first and second vehicles 201, 202 while the brush 206 is rotatably driven and/or while the maintenance assembly 203 outputs one or more maintenance solutions. This can include, in some applications, controlling a speed of coordinated movement of the first and second vehicles 201, 202 relative to PV modules 150 in correspondence to a flow rate at which one or more maintenance solutions are output from the maintenance fluid applicator 230. For instance, the controller 204 can be configured to control coordinated movement of the first and second vehicles 201, 202 relative to PV modules 150 at a higher speed when the maintenance fluid applicator 230 outputs a fluid cleaning solution, but configured to control coordinated movement of the first and second vehicles 201, 202 relative to PV modules 150 at a relatively lower speed when the maintenance fluid applicator 230 outputs a coating material. The rate at which the brush 206 is rotatably driven can also be controlled by the controller 204 corresponding to the speed of coordinated movement of the first and second vehicles 201, 202.

The illustrated embodiment here includes a first vehicle support shaft 220 at the first vehicle body 210 and a second vehicle support shaft 221 at the second vehicle body 212. Each of the first vehicle support shaft 220 and the second vehicle support shaft 221 can be coupled to the maintenance assembly 203. The controller can be configured to move at least one of the first vehicle shaft 220 and the second vehicle shaft 221 to adjust the positioning of the brush 206 relative to each of the first vehicle body 210 and the second vehicle body 212.

As shown at the example of FIG. 3A, the PV module 150 is oriented generally at horizontal, as such the controller 204 can actuate the first and/or second support shafts 220, 221 to orient the brush 206 also at horizontal to match the orientation of the PV module 150 (e.g., controller 204 can orient longitudinal and rotational axis 207 of brush 206 parallel to top surface of PV module 150).

The ability of the controller 204 to adjust the positioning of the maintenance assembly 203 (e.g., brush 206 and/or maintenance fluid applicator 230) can help the system 200 to adjust to variable terrain and spacing at a solar tracker system. FIGS. 3B and 3C illustrate examples of this. Thus, as the controller 204 controls the system 200 to move the first and second vehicle bodies 210, 212 in a coordinated manner relative to a row of a solar tracker, the controller 204 can also adjust the positioning of the maintenance assembly 203 as a function of variable ground terrain over which the first and second vehicle bodies 210, 212 move along adjacent the solar tracker row 120d.

As illustrated at the example of FIG. 3B, the controller 204 can be configured to adjust the positioning of the brush 206 relative to each of the first vehicle 201 and the second vehicle 202 by at least adjusting a spacing 245 between the first vehicle 201 and the second vehicle 202. The illustrated example shows that the controller 204 can be configured to translate the brush 206 relative to at least one of the first vehicle shaft 220 and the second vehicle shaft 221 to adjust spacing 245 defined between the first vehicle 201 and the second vehicle 202. In some such examples, the controller 204 can be configured to so translate the brush 206 by moving the brush 206 relative to at least one of the first vehicle shaft 220 and the second vehicle shaft 221. The ability to spacing 245 between the first vehicle 201 and the second vehicle 202 can allow the system 200 to adjust spacing 245 between the first and second vehicle bodies 210, 212 corresponding to the dimensions of the PV module 150 and/or the spacing between rows of a given tracker system so that the brush 206 is positioned to optimize/increase an area of the PV module over which the brush 206 performs the maintenance operation.

As illustrated at example of FIG. 3B, the controller 204 can be configured to adjust the positioning of the brush 206 relative to each of the first vehicle 201 and the second vehicle 202 by at least adjusting the elevational positioning of the brush 206 relative to each of the first vehicle 201 and the second vehicle 202. By adjusting the elevational positioning of the brush 206 at one, or both, of the vehicles 201, 202, an angular orientation 246 of the brush 206 (e.g., and of the maintenance assembly 203). Accordingly, the controller 204 can be raise and lower at least one of the first vehicle shaft 220 in direction 247 and the second vehicle shaft 221 in direction 248 to adjust the positioning of the brush 206 relative to each of the first vehicle 201 and the second vehicle 202. For instance, FIG. 3A shows the example where the second vehicle shaft 221 has been adjusted (e.g., raised) in elevation in direction 248 at the second vehicle 202 to cause the angular orientation 246 of the brush 206 to change from generally horizontal in FIG. 3B to be at a skewed angular orientation 246 at FIG. 3C. Yet, the controller 204 can so adjust the angular orientation 246 of the brush 206 (e.g., and maintenance assembly 203 more generally) to generally maintain the rotational axis 207 of the brush 206 parallel to the sun-facing surface of the PV module 150. For instance, this can help to adjust for ground elevational differences at opposite sides of row 120d—such as in FIG. 3C where the first vehicle 201 may be at a higher ground elevation at one side of the row 120d than the second vehicle 202 at the opposite side of the row 120d. Additionally or alternatively, this can help to adjust the system 200 to correspond to the tilt angle of the PV modules 150 at the row 120d.

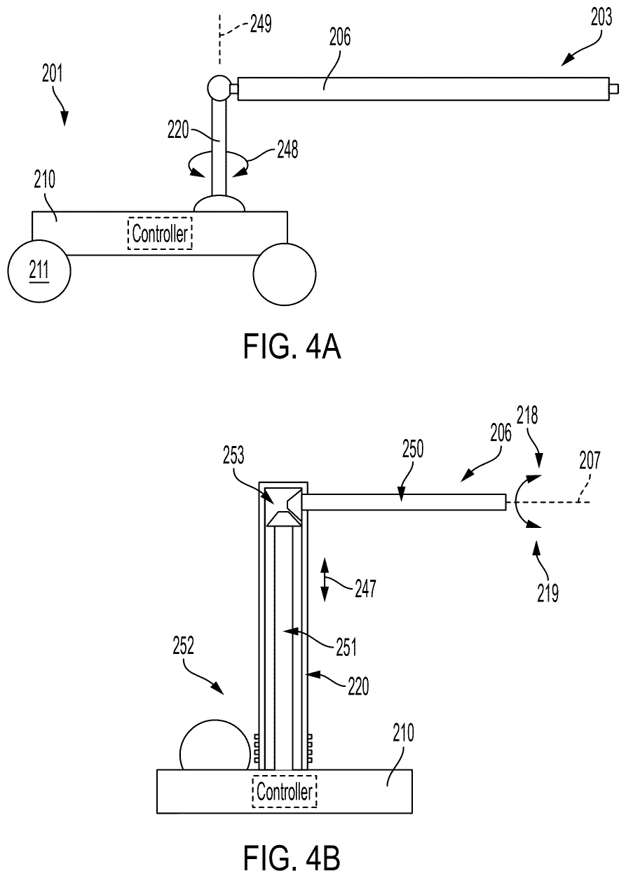

FIGS. 4A and 4B illustrate an exemplary embodiment of the first vehicle 201 of the tandem vehicular PV maintenance system 200. Specifically, 4A illustrates an elevational view of the first vehicle 201 of the system 200, and FIG. 4B illustrates a cross-section of the first vehicle 201 of the system 200.

As illustrated at the example of FIGS. 4A and 4B, the first vehicle body 210 can at least partially support the maintenance assembly 203. As shown here, the first vehicle body 210 can support the maintenance assembly 203 thereat such that the brush 206 is also at least partially supported at the first vehicle body 210. In this example, the first vehicle body 210 supports the maintenance assembly 203 via the shaft 220, which as previously noted can translate about a Z-axis (e.g., up and down in the illustrated orientation). The maintenance assembly 203 can include rotatable shaft 250 which can be driven (e.g., by controller) to cause the brush 206 to rotate about the axis 207 in direction(s) 218, 219. The brush 206 can be concentrically disposed around rotatable shaft 250. The rotatable shaft 250 can be supportably coupled to base shaft 251 (e.g., interior of the shaft 220) to rotatably support the rotatable shaft 250 at the first vehicle body 210. The illustrated example shows bevel gear 253 rotatably coupling shaft 250 to shaft 251. In addition to rotation of shaft 250, the controller can be configured to translate shaft 251 in directions 247. One example mechanism to facilitate this translation in directions 247 is a rack and pinion 252 to movably couple the shaft 251 to the shaft 220 to allow the shaft 251 to move the brush up and down in the directions 247. Furthermore, in addition to rotation of shaft 250 and translation of shaft 251 in directions 247, the controller can be configured to rotate the shaft 220 to cause rotation of the maintenance assembly 203 (e.g., including brush 206) in directions 248 about vertical shaft axis 249.

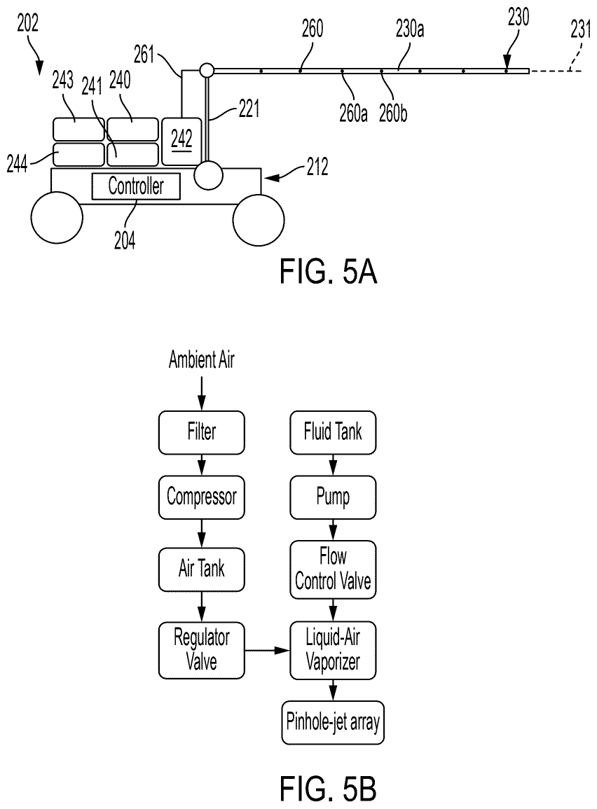

FIG. 5A illustrates an elevational view of second vehicle 202 of the tandem vehicular PV maintenance system 200. As illustrated at FIG. 5A, the second vehicle body 212 can at least partially support the maintenance fluid applicator 230. The maintenance fluid applicator 230 is disposed along the first axis 231 that extends from the second vehicle body 212. The maintenance fluid applicator 230 can work with the brush 206 to perform one or more maintenance operations at PV modules. For example, the maintenance fluid applicator 230 at the second vehicle body 202 can be disposed adjacent to the brush 206, with the illustrated example showing the maintenance fluid applicator 203 concentric to and nested relative to the brush 206. The maintenance fluid applicator 230 can include an array of nozzles 260 spaced apart along a fluid applicator shaft 230a. This fluid applicator shaft 230a can be disposed at least partially within the brush, and the fluid applicator shaft 230a can be in fluid communication with the reservoir 241 and/or air source 244 such that fluid from the reservoir 241 and/or the air source 244 can be output from the array of nozzles 260 and to one or more PV modules. As also shown here, the second vehicle body 212 can support air-liquid atomizer 242 such that fluid from the reservoir 241 and/or the air source 244 can pass through the air-liquid atomizer 242 prior to reaching the array of nozzles 260.

Accordingly, the maintenance fluid applicator 230 can be supported at the second vehicle body 202 and configured to output one or more maintenance solutions (e.g., a coating material and/or one or more liquid atomized maintenance solutions) onto one or more PV modules. In some applications, the array of nozzles 260 can be configured as function of the one or more maintenance solutions desired to be output from the array of nozzles 260. For example, the array of nozzles 260 can include a first set of nozzles 260a and a second set of nozzles 260b that define a different geometric cross-section than the first set of nozzles 260a such that the controller 204 can be configured to: (i) use the first set of nozzles 260a to output a first type of maintenance solution (e.g., a coating material), and (ii) use the second set of nozzles 260b to output a second type of maintenance solution (e.g., compressed air; a liquid cleaning solution, such as water and/or detergent).

FIG. 5B illustrates a functional block diagram for outputting an atomized maintenance solution (e.g., outputting an atomized cleaning solution, such as an atomized cleaning liquid solution; outputting an atomized coating; etc.). As shown here, ambient air can be intaken at an air filter to remove particulate from the ambient air. The compressor 243 can increase the pressure of this filtered ambient air and convey the pressurized air to air source 244 where the pressurized air can be stored until the controller initiates a control function, such as via a regulator valve, to convey the pressurized air from the air source 244 to the atomizer 242 such that the maintenance fluid applicator 230 outputs the atomized maintenance solution received from the atomizer 242 via fluid line 261. As also shown at FIG. 5B, the controller 204 can be configured to a liquid maintenance solution (e.g., a coating material, a liquid cleaning solution such as water and/or detergent, etc.) to pass from reservoir 241 to pump 240 to increase the pressure of the liquid maintenance solution. Then the controller 204 can initial a control function, such as via flow control valve, to convey pressurized liquid maintenance solution from the pump 240 to the atomizer 242 where the liquid maintenance solution from the reservoir 241 can be mixed together (e.g., atomized) with the pressurized air.

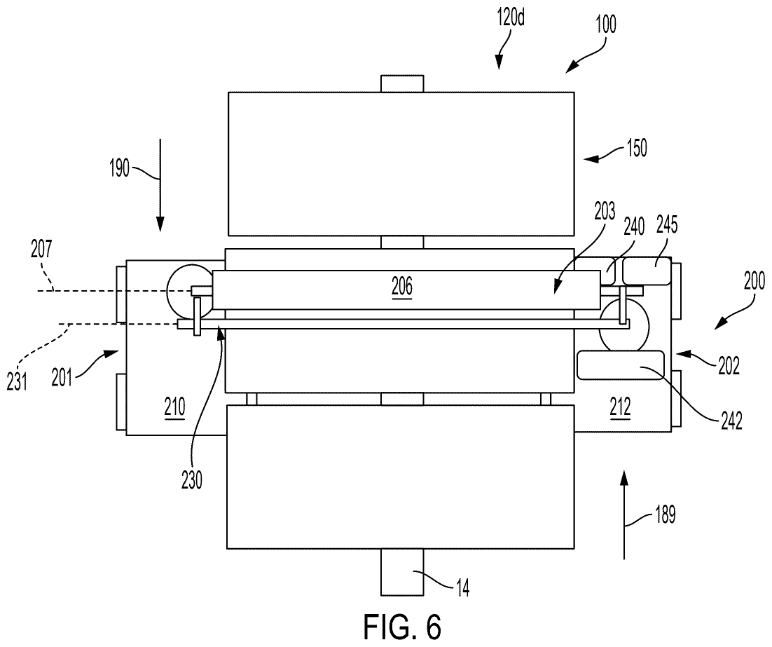

FIG. 6 is a top plan view of the tandem vehicular PV maintenance system 200 performing a maintenance operation along row 120d of solar tracking system 100. In some applications of the system 200 at row 120d of solar tracker system 100, the direction 189, 190 that the tandem vehicular PV maintenance system 200 moves relative to the row 120d can vary depending on the type of maintenance operation that the system 200 is performing at the PV modules 150 of the row 120d. For example, when the system 200 is to perform a maintenance operation that includes applying a coating material to one or more PV modules 150, the system 200 can move in the direction 190 relative to the row 120d. But when the system 200 is to perform a maintenance operation that includes applying a fluid cleaning solution (e.g., pressurized air and/or pressurized liquid cleaning solution), the system 200 can move in an opposite direction 189 relative to the row 120d.

FIG. 6 shows one example configuration of the system 200 to provide for execution of different maintenance operations at PV modules 150 when the system 200 travels in opposite directions 189, 190 relative to the row 120d. As illustrated here, the maintenance fluid applicator 230 is spaced apart from and offset, along a length of the system 200 in a direction parallel to the torque tube 14, from the maintenance assembly 203 (e.g., brush 206). Namely, the maintenance fluid applicator 230 can be disposed along axis 231 that extends between the first vehicle body 210 and the second vehicle body 212, and the brush 206 can be disposed along axis 207 that extends between the first vehicle body 210 and the second vehicle body 212, with this axis 207 of the brush 206 spaced apart from the axis 231 of the maintenance fluid applicator 230. This offset arrangement can result in the brush 206 acting at a given PV module 150 in sequence to the maintenance fluid applicator 230.

For instance, when the system 200 travels in the direction 190, the maintenance fluid applicator 230 can first output a coating material at a given region (e.g., a given region of PV module 150 of the row 120d) and then the brush 206 can encounter this given region after the coating material has been output there by the maintenance fluid applicator 230. Thus, when the system 200 travels in the direction 190, the brush 206 can be configured to finish (e.g., buff, polish, etc.) the coating material at the given PV module 150 such that the given PV module 150 is coated with the coating material. Thus, the controller 204 can be configured to cause the maintenance fluid applicator 230 to output a coating material at a first location at a photovoltaic module 150, and, after the coating material has been output at the first location, the controller 204 can be configured to cause the first vehicle 201 and the second vehicle 202 to move in tandem while causing the brush 206 to be rotatably driven along the first location to finish (e.g., buff) the coating thereat. In some such examples, the controller 204 can be configured to output the coating material at a coating deposition rate, and the controller 204 can be further configured to cause the first vehicle 201 and the second vehicle 202 to move in tandem at a speed, relative to the PV module 150, corresponding to the coating deposition rate. The coating material can vary depending on the application, though for maintenance operation at PV modules the coating material can include at least a hydrophobic coating material that is configured to reduce particulate accumulation at the photovoltaic module 150.

On the other hand, when the system 200 travels in the direction 189, the brush 206 can first clean (e.g., sweep) a given region (e.g., a given region of PV module 150 of the row 120d) and then the maintenance fluid applicator 230 can encounter this given region, after the brush has cleaned it, and apply one or more maintenance solutions (e.g., pressurized air and/or liquid cleaning solution) at the cleaned, given region. Thus, the controller 204 can be configured to cause the maintenance fluid applicator 230 to output a fluid cleaning solution at a first location at a photovoltaic module 150, and, prior to outputting the fluid cleaning solution at the first location, the controller 204 can be configured to cause the first vehicle 201 and the second vehicle 202 to move in tandem while causing the brush 206 to be rotatably driven along the first location to clean the first location with the brush 206 prior to outputting the fluid cleaning solution at the first location.

For instance, the controller 204 can be configured to cause the first vehicle 201 and the second vehicle 202 to move in tandem at a first speed relative to the row 120d when the system 200 is performing a maintenance operation that includes depositing a coating material. But when the system 200 is instead performing a maintenance operation that includes outputting a fluid cleaning solution, the controller 204 can be configured to cause the first vehicle 201 and the second vehicle 202 to move in tandem at a second, different (e.g., greater) speed relative to the row 120d.

Another embodiment includes a method for performing a maintenance operation at PV modules along a row of a solar tracker system using a tandem vehicular PV maintenance system. This method embodiment can include the steps of: moving a first vehicle body and a second vehicle body in tandem relative to the row of the solar tracker system to cause a brush carried by the first vehicle body and the second vehicle body to move along a first photovoltaic module of the row; and outputting a maintenance fluid at the first photovoltaic module as the first vehicle body and the second vehicle body are moved in tandem relative to the row of the solar tracker system.

In some applications of this method, the first vehicle and the second vehicle can be moved in tandem at a speed corresponding to a rate at which the maintenance fluid is output.

In some applications of this method, outputting the maintenance fluid includes outputting a hydrophobic coating material. For example, the first vehicle body and the second vehicle body can be moved in tandem relative to the row of the solar tracker system in a first direction to cause the hydrophobic coating material to be deposited at the first photovoltaic module. After depositing the hydrophobic coating material at the first photovoltaic module, the brush can be moved along the first photovoltaic module in the first direction to finish the coating at the first photovoltaic module.

In some applications of this method, outputting the maintenance fluid includes outputting an atomized fluid cleaning solution. For example, the first vehicle body and the second vehicle body can be moved in tandem relative to the row of the solar tracker system in a second direction (e.g., opposite the first direction) to cause the atomized fluid cleaning solution to be output at the first photovoltaic module. Prior to outputting the atomized fluid cleaning solution at the first photovoltaic module, the brush can be moved along the first photovoltaic module in the second direction to remove particulate accumulated on the first photovoltaic module.

In some applications, the tandem vehicular PV maintenance system can be controllable to move bi-directionally (e.g., north and south) relative to solar tracker row. Thus, the system can be controlled to move in one direction (e.g., north) to perform a cleaning operation using a fluid cleaning solution (e.g., compressed air, liquid cleaning solution) and to also be controlled to move in a second, opposite direction (e.g., south) to perform a coating operating using a coating material. Thus, as one such example, the system can be controlled to move in tandem along a row in one direction to clean PV modules at that row, and the system can be controlled to move in tandem along that same row in the opposite direction to apply (e.g., and finish) a coating at the PV modules at that row. For instance, the system can be controlled to move in tandem in the first direction to first execute a cleaning solution task at PV modules and then traverse back over the cleaned PV modules in the second, opposite direction to apply the coating to the recently cleaned PV modules.

Various non-limiting exemplary embodiments have been described. It will be appreciated that suitable alternatives are possible without departing from the scope of the examples described herein.

What is claimed is:

1. A tandem vehicular photovoltaic maintenance system comprising:
a first vehicle, the first vehicle comprising: a first vehicle body and one or more wheels coupled to the first vehicle body;
a second vehicle, the second vehicle comprising: a second vehicle body and one or more wheels coupled to the second vehicle body;
a maintenance assembly comprising a brush, the maintenance assembly supported at the first vehicle body and at the second vehicle body; and
a controller coupled to the maintenance assembly, wherein the controller is configured to adjust a positioning of the brush relative to each of the first vehicle and the second vehicle and to cause the brush to be rotatably driven relative to each of the first vehicle and the second vehicle.

2. The system of claim 1, wherein the controller is further configured to cause the first vehicle and the second vehicle to move in tandem while the brush is rotatably driven.

3. The system of claim 1, wherein the controller is configured to adjust the positioning of the brush relative to each of the first vehicle and the second vehicle by at least adjusting an angular orientation of the brush.

4. The system of claim 1, wherein the controller is configured to adjust the positioning of the brush relative to each of the first vehicle and the second vehicle by at least adjusting a spacing between the first vehicle and the second vehicle.

5. The system of claim 1,
wherein the first vehicle further comprises a first vehicle support shaft coupled to the maintenance assembly,
wherein the second vehicle further comprises a second vehicle support shaft coupled to the maintenance assembly, and
wherein the controller is configured to move at least one of the first vehicle shaft and the second vehicle shaft to adjust the positioning of the brush relative to each of the first vehicle and the second vehicle.

6. The system of claim 5, wherein the controller is configured to raise and lower at least one of the first vehicle shaft and the second vehicle shaft to adjust the positioning of the brush relative to each of the first vehicle and the second vehicle.

7. The system of claim 5, wherein the controller is further configured to translate the brush relative to at least one of the first vehicle shaft and the second vehicle shaft to adjust a spacing defined between the first vehicle and the second vehicle.

8. The system of claim 1, wherein the maintenance assembly is supported at the first vehicle body and at the second vehicle body such that the maintenance assembly extends between the first and second vehicle bodies and over a photovoltaic module at a row of a solar tracker.

9. The system of claim 1, wherein the maintenance assembly further comprises a maintenance fluid applicator, the controller configured to cause the maintenance fluid applicator to output a maintenance fluid.

10. The system of claim 9,
wherein the maintenance fluid applicator is disposed along a first axis that extends between the first vehicle body and the second vehicle body, and
wherein the brush is disposed along a second axis that extends between the first vehicle body and the second vehicle body, the second axis spaced apart from the first axis.

11. The system of claim 10,
wherein the controller is further configured to cause the maintenance fluid applicator to output a coating material at a first location at a photovoltaic module,
wherein, after the coating material has been output at the first location, the controller is configured to cause the first vehicle and the second vehicle to move in tandem while causing the brush to be rotatably driven along the first location to finish the coating.

12. The system of claim 11, wherein the controller is configured to output the coating material at a coating deposition rate, and wherein the controller is configured to cause the first vehicle and the second vehicle to move in tandem at a speed corresponding to the coating deposition rate.

13. The system of claim 11, wherein the coating material comprises a hydrophobic coating that is configured to reduce particulate accumulation at the photovoltaic module.

14. The system of claim 10,
wherein the controller is further configured to cause the maintenance fluid applicator to output a fluid cleaning solution at a first location at a photovoltaic module,
wherein, prior to outputting the fluid cleaning solution at the first location, the controller is configured to cause the first vehicle and the second vehicle to move in tandem while causing the brush to be rotatably driven along the first location to clean the first location with the brush prior to outputting the fluid cleaning solution at the first location.

15. The system of claim 9, wherein the maintenance fluid applicator comprises an array of nozzles spaced apart along a fluid applicator shaft, and wherein the fluid applicator shaft is disposed at least partially within the brush.

16. The system of claim 9, further comprising:
a fluid cleaning solution reservoir coupled to the maintenance fluid applicator;
a pump coupled to the controller and to the fluid cleaning solution reservoir; and
an atomizer coupled between the fluid cleaning solution reservoir and the maintenance fluid applicator to cause atomized fluid cleaning solution output from the maintenance fluid applicator.

17. A method of performing a maintenance operation at one or more photovoltaic modules along a row of a solar tracker system, the method comprising the steps of:
moving a first vehicle body and a second vehicle body in tandem relative to the row of the solar tracker system to cause a brush carried by the first vehicle body and the second vehicle body to move along a first photovoltaic module of the row; and
outputting a maintenance fluid at the first photovoltaic module as the first vehicle body and the second vehicle body are moved in tandem relative to the row of the solar tracker system.

18. The method of claim 17, wherein the first vehicle and the second vehicle are moved in tandem at a speed corresponding to a rate at which the maintenance fluid is output.

19. The method of claim 18,
wherein outputting the maintenance fluid comprises outputting a hydrophobic coating material,
wherein the first vehicle body and the second vehicle body are moved in tandem relative to the row of the solar tracker system in a first direction to cause the hydrophobic coating material to be deposited at the first photovoltaic module, and
wherein after depositing the hydrophobic coating material at the first photovoltaic module, moving the brush along the first photovoltaic module in the first direction to finish the coating at the first photovoltaic module.

20. The method of claim 19,
wherein outputting the maintenance fluid comprises outputting an atomized fluid cleaning solution,
wherein the first vehicle body and the second vehicle body are moved in tandem relative to the row of the solar tracker system in a second, opposite direction to cause the atomized fluid cleaning solution to be output at the first photovoltaic module, and
wherein prior to outputting the atomized fluid cleaning solution at the first photovoltaic module, moving the brush along the first photovoltaic module in the second direction to remove particulate accumulated on the first photovoltaic module.
